(19) United States
(12) Patent Application Publication
(10) Pub. No.: US 2026/0192957 A1
(43) Pub. Date: Jul. 9, 2026

(54) SYSTEM FOR PROCESSING FOOD PORTIONS AND METHOD OF OPERATING SUCH A SYSTEM

(71) Applicant: GEA Food Solutions Germany GmbH, Biedenkopf-Wallau (DE)

(72) Inventors: Konstantin Kechler, Nürtingen (DE); Steffen Bamberger, Dautphetal (DE); Maximilian Fikentscher, Kempten (DE); Frederik Blatter, Memmingen (DE); Stefan Maidel, Kempten (DE)

(21) Appl. No.: 19/130,983

(22) PCT Filed: Nov. 6, 2023
(86) PCT No.: PCT/EP2023/080792

§ 371 Date: May 19, 2025

(30) Foreign Application Priority Data
Nov. 21, 2022 (DE) 102022212413.8

(51) Int. Cl. B65B 35/44; A22C 17/00; B65B 35/24; B65B 35/36; B65G 43/08

(52) U.S. Cl. CPC B65B 35/44; A22C 17/0093; B65B 35/246; B65B 35/36; B65G 43/08; B65G 2201/0202

(57) ABSTRACT

System for processing food portions that includes at least one processing station arranged upstream for producing and/or processing the food portions, at least one further processing station arranged downstream for further processing the food portions, at least one transfer station arranged downstream of the processing station and upstream of the further processing station, the at least one transfer station having at least one first automatic transfer unit for transferring the food portions from the processing station to the further processing station and having a first conveyor belt for conveying the food portions along a first conveying direction and at least one buffer station arranged downstream of the transfer station for the intermediate storage of the food portions with a second conveyor belt for conveying and intermediate storage of the food portions, the first conveyor belt and the second conveyor belt are designed as retracting belts.

### CROSS REFERENCE TO RELATED APPLICATIONS

This application is a US National Stage Entry of PCT/EP2023/080792 filed on Nov. 6, 2023, which claims priority to DE 10 2022 212 413.8 filed on Nov. 21, 2022, the entireties of which are all incorporated by reference herein for all purposes.

### BACKGROUND

The present invention is based on a system for processing food portions, the system comprising at least one processing station arranged upstream for producing and/or processing food portions, at least one further processing station arranged downstream for further processing the food portions, at least one transfer station arranged downstream of the processing station and upstream of the further processing station with at least one first automatic transfer unit for transferring food portions from the processing station to the further processing station and with a first conveyor belt for conveying food portions along a first conveying direction, and at least one buffer station arranged downstream of the transfer station for intermediate storage of food portions with a second conveyor belt for conveying and intermediate storage of food portions.

One example of such a processing station is a device for cutting food into slices. In such devices-so-called “slicers”-bar-shaped food products, such as sausage or cheese, are cut into slices. The cut slices are usually arranged in portions and conveyed by the first conveyor belt of the slicer in one or more lanes downstream along the first conveying direction to the further processing station. Since a new food product has to be inserted after a bar-shaped food product has been sliced, or because, for example, incorrectly weighted or otherwise faulty food portions are sorted out, it can happen that there is not a constant number of food portions on the first conveyor belt and, in extreme cases, there may even be no food portions in a particular section for a (short) period of time.

An example of a further processing station is a device for packaging the food portions. One or more food portions are arranged in a predetermined number, a predetermined arrangement and/or a predetermined weight in packaging. For example, packaging cavities are formed in a film web and the food portions are inserted into the packaging cavities and, if necessary, sealed. For this purpose, the food portions must be arranged in a fixed predetermined arrangement, a so-called format, in the further processing station.

The arrangement of the food portions in which they are provided by the processing station does not usually correspond to the arrangement required by the further processing station. A direct transfer from the processing station to the further processing station is therefore usually ruled out.

As already mentioned at the beginning, the food portions can also be manipulated in a variety of ways during transportation from the processing station to the further processing station. For example, food portions can be weighed and faulty food portions, such as underweight food portions, can be ejected and/or supplemented.

Furthermore, due to the discontinuous provision of food portions by the processing station and the continuous requirement of the further processing station, it is often necessary to temporarily store food portions. Buffer stations are known for this purpose, which for example comprise a complex system of conveyor belts at several heights, to which food portions can then be fed or removed.

However, all these stations require a considerable amount of installation space in the first conveying direction, which is often only available to a limited extent.

### SUMMARY

It is therefore a task of the present invention to provide a system for processing food portions, which easily transfers food portions provided by a processing station into an arrangement required by a further processing station and in particular enables continuous operation of the further processing station, while at the same time the system requires as little installation space as possible in the first conveying direction.

The problem of the present invention is solved by a system according to claim 1.

The system according to the invention for processing food portions comprises at least one upstream processing station for producing and/or processing food portions. Preferably, the processing station is a device for slicing food products, in particular a so-called high-performance slicer. Alternatively or additionally, the processing station comprises further components, such as a weighing unit and/or a conveyor belt for conveying the food portions along a conveying direction, in particular along the first conveying direction. However, it is particularly advantageous if the processing station transfers the food portions directly to the first conveyor belt of the transfer station. Furthermore, according to the invention, the system comprises at least one further processing station arranged downstream for further processing the food portions. Preferably, the further processing station is a device for packaging food portions, in particular a thermoforming packaging machine. It is particularly advantageous if the transfer station places the food portions directly into packaging trays. Alternatively or additionally, the further processing station comprises further components, such as a conveyor belt for conveying the food portions along a second direction. Furthermore, the system according to the invention comprises at least one transfer station arranged downstream of the processing station and upstream of the further processing station with at least one first automatic transfer unit for transferring food portions from the processing station to the further processing station and with a first conveyor belt for conveying food portions along a first conveying direction. Preferably, the automatic transfer unit is designed to independently detect food portions in a working area and, in particular, to transfer them to the further processing station in a predetermined arrangement, position and/or orientation.

In addition, the system also comprises at least one buffer station arranged downstream of the transfer station for the temporary storage of food portions with a second conveyor belt for conveying and temporarily storing food portions. The buffer station therefore serves in particular as (temporary) storage for food portions. Preferably, the buffer station essentially comprises only the second conveyor belt, i.e. in particular no grippers, no large number of conveyor belts or other complex elements. The second conveyor belt particularly preferably has a length that is selected such that the buffer station has sufficient buffer capacity. The skilled person understands that this depends on the overall system, for example the conveying capacity of the first conveyor belt, the operating speed of the transfer station and/or the operating speed of the processing station.

According to the invention, it is now provided that the first conveyor belt and the second conveyor belt are designed as retraction belts. The fact that the second conveyor belt and the third conveyor belt are designed as retraction belts according to the invention makes it possible in a particularly advantageous manner to convey food portions stored on the second conveyor belt back into the area of the transfer station, in particular the (first and/or second) automatic transfer unit. Preferably, this is done when the transfer station is not at full capacity. Preferably, each retraction belt has at least one edge that can be moved parallel to the first conveying direction. It is particularly preferable for the retraction belt to be designed in such a way that its overall length can be varied by moving the edge. The edge is in particular a transfer edge between two conveyor belts, for example between the first conveyor belt and the second conveyor belt or vice versa. In the context of the present invention, the term retracting belt is to be understood in particular as a conveyor belt which is movable at at least one end in a first direction, here for example the first conveying direction, and back, and in particular is variable in its length. By designing the first conveyor belt and the second conveyor belt as retraction belts, it is possible in a particularly advantageous manner to fill and empty the buffer station in a targeted manner.

The system is therefore preferably configured in such a way that the transfer station transfers some of the incoming food portions (from the processing station) to the further processing station, in particular directly into packaging trays, while another portion of food portions, which is not picked up by the transfer station, is stored in the buffer station and in particular on the second conveyor belt. If the number of incoming food portions per unit of time decreases, for example due to a change of food product in the processing station, the food portions stored in the buffer station can be advantageously fed to the transfer station so that it can transfer food portions to the further processing station without loss of productivity and/or without interruption. In this way, a very efficient system for processing food portions is provided with a particularly simply designed buffer station.

The explanations relating to this object of the present invention also apply to the other objects of the present invention and vice versa.

Preferably, a food portion comprises one or more slices of a food product, for example sausage or cheese. More generally, a food portion comprises one or more food products or parts thereof grouped together. In particular, neither the type, number or weight of one or more food portions is decisive for the present invention, but rather that the food portions are distinguishable from one another. This means, in particular, that the transfer station can specifically identify one or more food portions and transfer them to the fourth conveyor belt.

Preferably, the system further comprises a controller for controlling the system, wherein the controller is designed in particular to control the processing station, the transfer station, the buffer station and/or the further processing station.

According to a further preferred embodiment of the invention, it is provided that a distance of the transfer edges between the first conveyor belt and the second conveyor belt is substantially constant. Preferably, the second conveyor belt is arranged such that it directly adjoins the first conveyor belt, in particular such that the food portions are conveyed directly from the first conveyor belt to the second conveyor belt. When transporting the food portions in the first conveying direction, the first conveyor belt transfers the food portions to the second conveyor belt at a transfer edge. When transporting the food portions in the opposite direction, the second conveyor belt transfers the food portions to the first conveyor belt at a transfer edge. To ensure an error-free transfer, the distance between the first conveyor belt and the second conveyor belt is therefore preferably as small as possible. Particularly preferably, the first conveyor belt and the second conveyor belt are now designed in such a way that the relative positioning between the first conveyor belt and the second conveyor belt remains unchanged despite an absolute change in position of the transfer edges. It is particularly preferred that the first conveyor belt and the second conveyor belt have a common conveying plane at least in the area of the transfer edges

Alternatively or additionally, the distance between the first conveyor belt and the second conveyor belt in the area of the transfer edges can be changed at least in two stages, whereby in particular a gap can be created at least temporarily between the first conveyor belt and the second conveyor belt. This makes it possible, in an advantageous manner, to create a gap through which food portions can be ejected as required, for example defective food portions.

Alternatively, it is provided that the first conveyor belt is arranged at a higher conveying level than the second conveyor belt in the area of the transfer edge when the food portions are transported in the first conveying direction. In particular, this means that the first conveyor belt is arranged with the transfer edge at least partially above the second conveyor belt. The food portions are thus transferred to the second conveyor belt, in particular with the aid of gravity at the transfer edge. Preferably, the second conveyor belt is provided in such a way that it can be moved to a conveyor level in the area of the transfer edge above the first conveyor belt. This makes it possible, in particular in an advantageous manner, for only the second conveyor belt to be designed as a retracting belt, whereby the transfer edge of the second conveyor belt is moved to transport the food portions stored in the buffer station into the working area of the transfer station.

According to a further preferred embodiment, it is provided that the first conveying direction and the second direction are provided parallel to each other at least in sections, the first conveying direction being unequal to the second direction, preferably the first conveying direction and/or the second direction being provided in a straight line at least in sections. It is thus possible in a particularly advantageous manner to provide a particularly compact system, since the further processing station can be arranged in particular at least in sections next to the first and/or second conveyor belt and/or the processing station. Although a rectilinear design of the first conveying direction and/or the second direction is not mandatory, it enables a particularly simple design of the system.

A preferred embodiment of the invention provides that the first conveyor belt and the second conveyor belt are arranged along the first conveying direction, in particular in a linear extension of the processing station and/or directly adjacent thereto. Particularly preferably, the transfer station is provided immediately following the processing station in the first conveying direction and, in particular, the first conveyor belt is provided immediately following the processing station in the first conveying direction. Very preferably, the buffer station is provided in the first conveying direction directly following the transfer station and, in particular, the second conveyor belt is provided in the first conveying direction directly following the first conveyor belt. This also makes a compact system possible in an advantageous manner.

According to yet another preferred embodiment, it is provided that the transfer station comprises a second automatic transfer unit for transferring food portions from the processing station to the further processing station, wherein the second automatic transfer unit is preferably arranged along the first conveying direction between the first automatic transfer unit and the buffer station or between the processing station and the first automatic transfer unit. Particularly preferably, the second automatic transfer unit is substantially identical to the first automatic transfer unit. Very preferably, the working areas of the first automatic transfer unit and the second automatic transfer unit are provided without overlapping. The provision of a second automatic transfer unit significantly increases the operating speed of the transfer station and thus of the transfer station in an advantageous manner.

A further preferred embodiment of the invention provides for the first automatic transfer unit and/or the second automatic transfer unit to be movable in three dimensions and/or rotatable about at least one axis, in particular two or three axes aligned perpendicularly to one another, wherein the first automatic transfer unit and/or the second automatic transfer unit preferably comprises at least one robot for picking up and transferring food portions. Preferably, the robot is a picker and/or a robot loader. Particularly preferably, the robot is configured to identify and pick up food portions, in particular during the movement of the second conveyor belt, and to transfer them non-destructively to the further processing station, where they are deposited at a predetermined position and/or in a predetermined orientation. Very preferably, the working area of the first automatic transfer unit and/or the second automatic transfer unit is essentially circular, with the center of the working area being provided in particular between the first conveyor belt and the further processing station. This advantageously makes it possible to provide an efficient, versatile automatic transfer unit that can quickly transfer a large number of food portions.

According to a preferred embodiment, it is provided that the first conveyor belt and/or the second conveyor belt comprises an endless belt. Such an endless belt or endless conveyor belt is a particularly simple and proven technique for realizing conveyor belts.

According to a further preferred embodiment, it is provided that the system further comprises at least one detection means, in particular an optical detection means, for detecting food portions, wherein the detection means is preferably arranged in the area of the processing station, the first conveyor belt and/or the second conveyor belt. Such an (optical) detection means is also referred to in particular as a vision system. Particularly preferably, the detection means is provided in the transition area between the processing station and the first conveyor belt. Very preferably, the detection means is designed in such a way that it detects the presence of food portions and/or the occupancy (of a conveyor belt) in a detection area. In the context of the present invention, occupancy is to be understood in particular as the temporal sequence and/or the spatial arrangement of food portions. In this way, it is particularly advantageous to be able to control the system optimally, since, for example, the operating speed of the processing station, the transfer station, the buffer station and/or the further processing station can be controlled as a function of the presence of food portions and/or as a function of the occupancy.

A preferred embodiment of the invention provides for the processing station, the first conveyor belt, the second conveyor belt and/or the further processing station to be provided with multiple tracks. In this way, the operating speed of the system can be increased in an advantageous manner.

According to a further preferred embodiment, it is provided that the first conveyor belt and the second conveyor belt have the same number of tracks, wherein preferably the first conveyor belt and the second conveyor belt have a number of tracks which is unequal to the number of tracks of the further processing station. The number of tracks of the further processing station is, for example, the number of packaging troughs arranged next to each other transversely to the second conveying direction, whereas the number of tracks of the processing station particularly preferably determines the number of tracks of the first conveyor belt and/or the second conveyor belt. This makes it advantageously possible to dispense with additional stations for merging and/or separating tracks, making the system simpler and more compact to implement.

A preferred embodiment of the invention provides that the first conveyor belt and the second conveyor belt are arranged at least temporarily on one level, so that the food portions are arranged on a preferably horizontal conveying level. This further simplifies the system in an advantageous manner, since the food portions are only conveyed on one level.

According to yet another preferred embodiment of the invention, it is provided that the second conveyor belt is arranged at least temporarily on a different level than the first conveyor belt. This is to be seen in particular in connection with the above explanations, according to which at least the transfer edge of the second conveyor belt is arranged at least temporarily above the first conveyor belt or vice versa. This advantageously simplifies the transfer between the conveyor belts.

According to another preferred embodiment of the present invention, it is provided that the conveying direction of the first conveyor belt and/or the second conveyor belt can be reversed at times. This further increases the efficiency of the system in a particularly advantageous manner. In addition to the transfer of the food portions to the working area of the transfer station via the retraction belt, the food portions stored on the second conveyor belt can also be conveyed faster towards the transfer station and in particular to the working area of the first and/or second automatic transfer unit by reversing the conveying direction. Preferably, the conveying direction is reversed when a predetermined storage occupancy of the second conveyor belt is exceeded and/or when the occupancy of the first conveyor belt falls below a predetermined value. The overall operating speed of the system is advantageously increased if the displacement of the second conveyor belt is additionally supported by a reversal of the conveying direction, as the food portions stored on the second conveyor belt thus reach the working area of the transfer station more quickly.

A further object of the present invention is a method of operating a system according to the invention, wherein food portions are produced by the processing station and conveyed along the first conveying direction by the first conveyor belt towards the second conveyor belt, wherein the automatic transfer station transfers food portions from the first conveyor belt to the further processing station, wherein non-converted food portions are conveyed to the second conveyor belt of the buffer station for intermediate storage, wherein the transfer edge of the first conveyor belt and/or the second conveyor belt is moved in the opposite direction to the first conveying direction when a predetermined first condition is fulfilled.

The explanations relating to this object of the present invention also apply to the other objects of the present invention and vice versa.

The method is particularly advantageous as it enables highly efficient and comparatively fast processing of food portions, in particular ensuring continuous operation of the further processing station, even if the processing station operates discontinuously.

According to a preferred embodiment of this object of the invention, it is provided that the system comprises at least one detection means, in particular an optical detection means, for detecting food portions, wherein the detection means is preferably arranged in the area of the processing station, the first conveyor belt and/or the second conveyor belt and detects the occupancy, wherein the predetermined first condition is fulfilled when the occupancy falls below a predetermined first value. The occupancy is in particular the temporal and/or spatial sequence of food portions in the area monitored by the detection means. In an advantageous way, this ensures that the transfer unit can always continue to work without interruption, even if, for example, fewer or no more food portions are delivered due to a change of food product in the processing station. In this case, food portions are provided by the buffer station.

Alternatively or additionally, exceeding a fill level of the buffer station can also be provided as a condition. In this way, it is advantageously possible for food portions to be fed from the buffer station to the transfer unit if the buffer station, in particular the second conveyor belt, exceeds a certain fill level in order to prevent the buffer station from being able to receive any further food portions.

According to a preferred further development of this object of the invention, it is provided that the conveying direction of the first conveyor belt and/or the second conveyor belt is temporarily reversed when a predetermined second condition is fulfilled, wherein the predetermined second condition is fulfilled in particular when the occupancy falls below a predetermined second value, wherein the second value is lower than the first value. Alternatively, the conveying direction of the first conveyor belt and/or the second conveyor belt can always be reversed simultaneously or with a time delay during a movement of the transfer edge. In this way, it can be ensured that all food portions stored in the buffer station are made available to the transfer station. If the reversal of the conveying direction depends on a second condition, this is particularly advantageous if it is recognized that no further food portions are supplied by the processing station, so that no problems occur during the transfer between the processing station and the first conveyor belt when the conveying direction of the first conveyor belt is reversed. It is particularly advantageous that if the occupancy of the processing station and/or the first conveyor belt is greater than zero but less than a predetermined occupancy and the transfer edge is shifted, only the conveying direction of the second conveyor belt is initially reversed. In this way, the food portions provided by the processing station are still transported by the first conveyor belt through the transfer station, while at the same time the conveying direction of the second conveyor belt is reversed and the food portions stored in the buffer station are fed to the transfer station. Preferably, this is used when the transfer station has a first and a second automatic transfer unit, since in this case the automatic transfer unit positioned closer to the processing station transfers the food portions provided by the processing station to the further processing station (or a component connected to it, such as a conveyor belt), while the other automatic transfer unit transfers the food portions provided by the buffer station. This enables the processing station to work continuously in a particularly advantageous way.

According to a further preferred embodiment of this object of the invention, it is provided that the speed of the second conveyor belt and/or the third conveyor belt is controlled as a function of the detected occupancy. This advantageously enables optimized process control.

According to yet another preferred embodiment of this object of the invention, it is provided that a gap between the first conveyor belt and the second conveyor belt is deliberately created at least temporarily. This is particularly preferably achieved by displacing the transition edge of the first conveyor belt and/or the second conveyor belt. This allows defective, for example incomplete and/or underweight, food portions to be ejected in an advantageous manner, in particular into a collecting device arranged under the conveyor belts.

### BRIEF DESCRIPTION OF THE DRAWINGS

FIG. 1 shows a schematic top view of a system according to the invention in accordance with an exemplary embodiment.

FIGS. 2a and 2b show a schematic representation of a method according to the invention according to an exemplary embodiment at different points in time.

FIG. 3 shows a schematic top view of a system according to the invention in accordance with an exemplary embodiment.

FIG. 4 shows a schematic top view of a system according to the invention in accordance with an exemplary embodiment.

FIG. 5 shows a schematic representation of a first and second conveyor belt according to an exemplary embodiment of the system according to the invention.

FIGS. 6a to 6f show a schematic representation of a method according to the invention according to an exemplary embodiment at different points in time.

### DETAILED DESCRIPTION

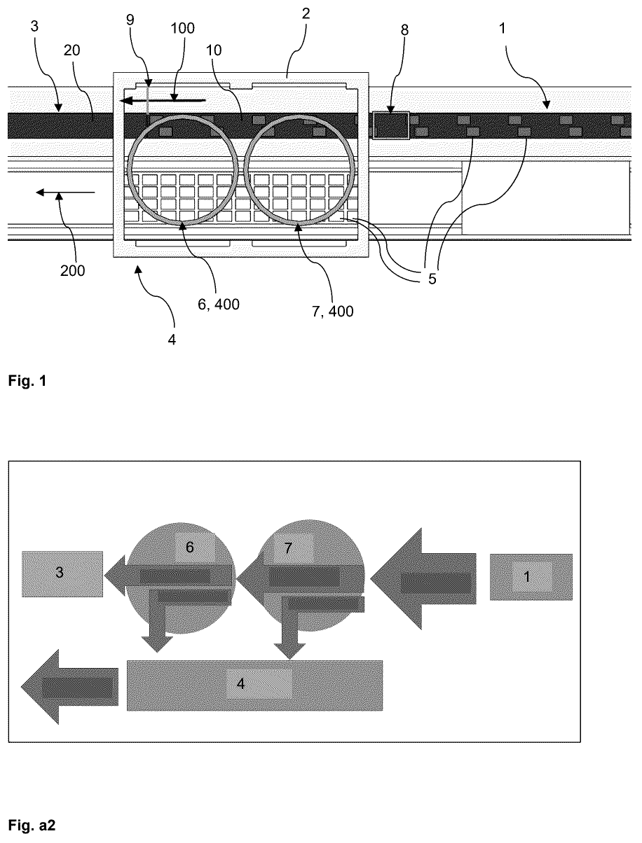

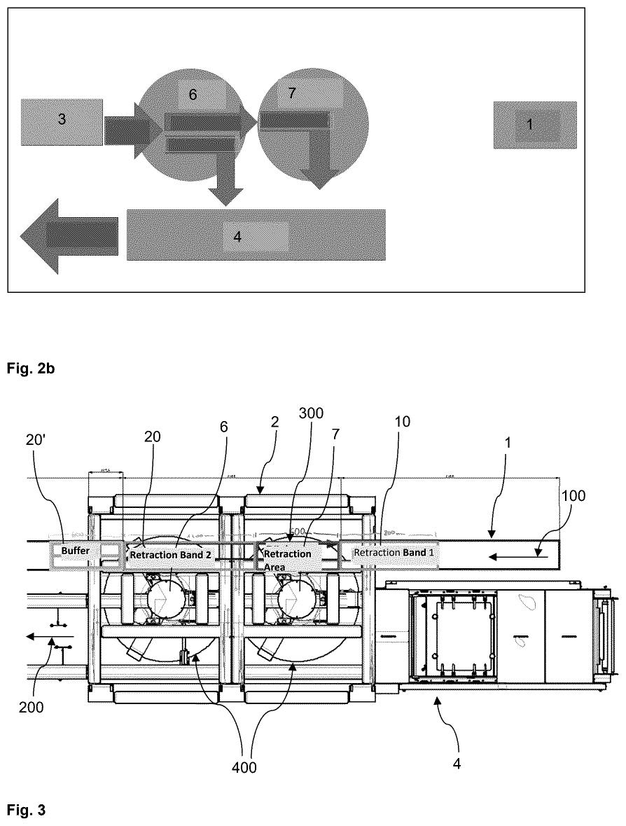

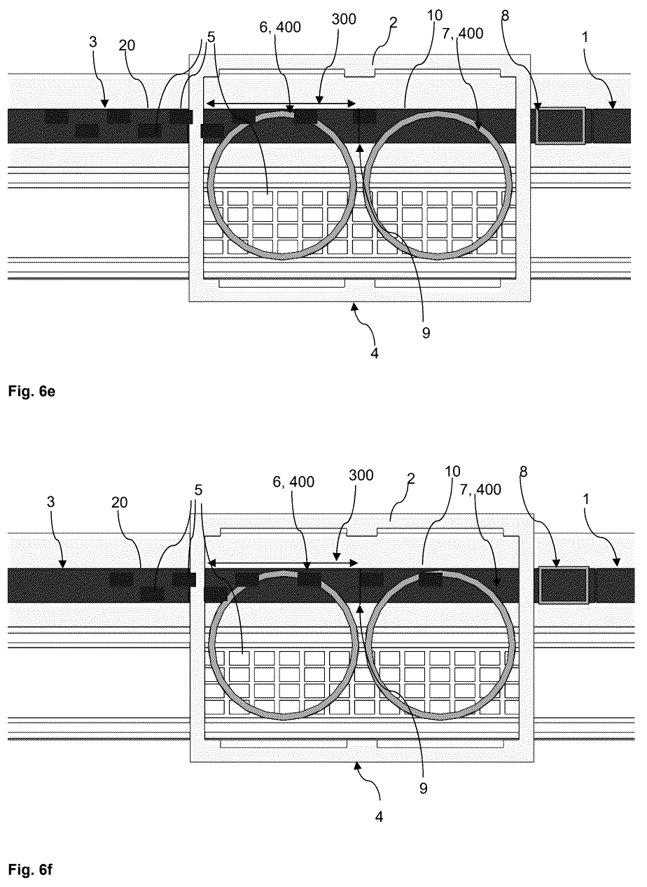

FIG. 1 shows a schematic top view of a system according to the invention in accordance with an exemplary embodiment. The main components of the system according to the invention are presented below with reference to FIG. 1, while the mode of operation of the system is explained with reference to FIGS. 2a and 2b and FIGS. 6a to 6f.

The system according to the invention for processing food portions can also be referred to as a food processing line. It comprises a processing station 1 for producing and/or processing food portions. This is, for example, a high-performance slicer that slices up bar-shaped food products such as cheese or sausage and thus produces food slices. Food portions 5 are formed from these food slices, for example depending on their weight, with a food portion 5 comprising at least one food slice. Of course, the system according to the invention can also be implemented with other types of processing stations and the food portions are also not limited to food slices. The processing station 1 comprises here, for example, a conveyor belt which transports the food portions 5 provided by the processing station 1 along a first conveying direction 100. However, this conveyor belt is purely exemplary. It is also possible that the processing station transfers the food portions directly to the subsequent first conveyor belt 10 and/or that the processing station 1 comprises further components such as a weighing unit for weighing the food portions 5 and/or a stacking and/or sizing unit

Here, the system further comprises an optional detection means 8 arranged at the end of the processing station 1, for example an optical detection means such as a camera, with the aid of which the system can detect the occupancy with food portions 5 The occupancy is the temporal and/or spatial sequence and/or arrangement of food portions 5 in the detection area of the detection means 8. In particular, the detection means 8 detects how many food portions 5 are provided per unit of time in a predetermined moment by the processing station 1. Additionally or alternatively, the detection means 8 or a further detection means can also be provided at another position, for example in the area of the first conveyor belt 10 and/or the second conveyor belt 20 explained below.

The food portions 5 provided by the processing station 1 are to be conveyed to a downstream further processing station 4 with a second (processing) direction 200. Such a further processing station 4 is preferably a packaging machine that inserts the food portions 5 into packages and preferably closes them. One example of such a packaging machine is a thermoforming packaging machine that inserts a plurality of adjacent packaging cavities into a film web transversely to the second direction 200, places the food portions 5 into the packaging cavities and then closes them with a lidding film. Since the packaging trays are formed in a fixed arrangement, the food portions 5 must be fed to the further processing station 4 in accordance with the arrangement of the packaging trays. An arrangement of four food portions 5 arranged next to each other is shown here purely as an example. The further processing station 4 is therefore preferably provided with multiple lanes. As is indicated here, however, the food portions 5 are provided by the processing station 1 here only in two rows and, in particular, not perfectly arranged next to one another. Preferably, the first conveyor belt 10 is also provided with multiple lanes. Therefore, the food portions 5 from the processing station 1 must be rearranged for the further processing station 4. For this purpose, devices are known that can arrange the food portions 5 in so-called formats. However, these devices have a complex structure and significantly increase the overall length of the system.

Immediately following the processing station 1, a transfer station 2 is therefore provided with at least one first automatic transfer unit 6 for transferring the food portions 5 from the processing station 1 to the further processing station 4. According to the invention, the transfer station 2 comprises at least one automatic transfer unit 6, in this case even a second automatic transfer unit 7 arranged next to the first automatic transfer unit 6, in order to increase the overall capacity of the system. Such an automatic transfer unit 6, 7 preferably comprises a robot, for example a so-called picker and/or robot loader, which automatically picks up one or more food portions 5 and transfers them to the further processing station according to the required arrangement. For this purpose, the automatic transfer units 6, 7 are preferably movable in three dimensions and/or rotatable about at least one axis, in particular two or three axes aligned perpendicular to each other. The first and second automatic transfer units 6, 7 are designed in particular in such a way that they can transfer food portions 5 within a predetermined working area 400, which in this case is essentially circular. Particularly preferably, the first automatic transfer unit 6 and the second automatic transfer unit 7 are designed in essentially the same way.

For the sake of simplicity, a distinction is made here between the processing station 1 and the first conveyor belt 10 of the transfer station 2. However, this distinction is in particular purely functional; structurally, on the other hand, it can in particular be an uninterrupted conveyor belt that starts from the processing station 1 and leads into the transfer station 2. The first conveyor belt 10 can thus preferably be functionally assigned to the processing station 1, at least in sections.

Since the number of food portions 5 provided by the processing station 1 can vary and the further processing station 4 should normally operate continuously, the system according to the invention further comprises a buffer station 3, which comprises a second conveyor belt 20. The second conveyor belt 20 is different from the first conveyor belt 10. The second conveyor belt 20 is preferably provided in such a way that its conveying direction can be reversed if necessary. Since the buffer station 3 is arranged (immediately) after the transfer station 2, it can receive and store food portions 5 that are not picked up by the transfer station 2 and, if necessary, in particular if too few or no food portions 5 are provided by the processing station 1, feed them back to the transfer station 2 so that the latter can operate constantly, independently of the processing station 1. The buffer station 3 thus serves as a (temporary) food portion store

A particularly preferred embodiment is shown here, in which the first conveying direction 100 is rectilinear and the first conveyor belt 10 and the second conveyor belt 20 are arranged in direct succession and, in particular, following the processing station 1 along this first conveying direction 100. The second direction 200 of the further processing station 4 is aligned here parallel to the first conveying direction 100, but offset from it. This arrangement is particularly advantageous, since a linear design is particularly easy to realize and such a line or system is easy to install within a factory hall. Furthermore, the relative arrangement between the processing station, the further processing station 4, the first conveyor belt 10 and the second conveyor belt 20 or the relative arrangement of the first conveying direction 100 and the second (conveying) direction 200 is particularly advantageous, since part of the system is thus arranged in parallel, which reduces the overall length and thus the space requirement of the system in an advantageous manner.

In accordance with the invention, the first conveyor belt 10 and the second conveyor belt 20 are now designed as retracting belts. A retracting belt is a special design of a conveyor belt known to the skilled person, in which, in particular, a transfer edge is displaceable parallel to a conveying direction.

According to the embodiment shown here, the processing station 1, the first conveyor belt 10 and the second conveyor belt 20 are arranged on a common conveying plane. This conveying plane is preferably aligned essentially horizontally. Here, the first conveyor belt 10 and the second conveyor belt 20 are now arranged in direct succession in a conveying plane with a transfer edge arranged between the conveyor belts 10, 20, at which food portions 5 are transferred along the first conveying direction 100 from the first conveyor belt 10 to the second conveyor belt 20. In a manner still to be explained, the transfer edge 9 between the two conveyor belts 10, 20 can be displaced parallel to the first conveying direction 100 under certain conditions, the distance between the first conveyor belt 10 and the second conveyor belt 20 preferably being kept constant at least temporarily in order to ensure problem-free transfer of food portions 5 between the belts 10, 20. In particular, this makes it possible to move the food portions 5 stored in the buffer station 3, which preferably comprises essentially only the second conveyor belt 30, into the working area of the transfer station 2, in particular the first automatic transfer unit 6 or the second automatic transfer unit 7. In addition, the conveying direction of the second conveyor belt 20 and possibly also of the first conveyor belt 10 can be reversed in a manner also explained in more detail below, in order to move all the food portions 5 stored on the second conveyor belt 20 into the working area 400 of the transfer station 2. In this case, the first conveyor belt 10 and/or the second conveyor belt 20 are thus moved in the opposite direction to the first conveying direction 100. The transfer edge 9 is additionally symbolized here by a dash next to the conveyor belts 10, 20 for better visibility.

The processing station 1 thus provides food portions 5, which are conveyed to a transfer station 2, whereby during operation, some of the food portions 5 are generally transferred by the transfer station 2 in a predetermined arrangement to the further processing station 4 and there, in particular, directly into packaging trays and/or packaging trays, and another part of the food portions 5 passes through the transfer station 2 without being transferred and arrives in a buffer station 3, in which they are temporarily stored. Under certain conditions, the food portions 5 are made available to the transfer station 2 by the buffer station 3 and then transferred to the further processing station 4. Here, this is particularly preferably done by the first conveyor belt 10 of the transfer station 2 and the second conveyor belt 20 of the buffer station 3 being designed as retracting belts, so that a transfer edge 9 between the second conveyor belt 20 and the first conveyor belt 10 can be moved parallel to the first conveying direction 100.

FIGS. 2a and 2b, which show a schematic representation of a method according to the invention according to an exemplary embodiment at different points in time, are used to explain the system according to the invention and the method according to the invention for operating the system in more detail. For the sake of clarity, exemplary numerical values for operating speeds of the individual stations are given below. These are to be understood as purely illustrative and do not restrict the idea according to the invention.

FIG. 2a shows a phase of the process in which the buffer station 3 is filled. The processing station 1 on the right of the picture, for example, provides around 120 food portions 5 per minute. These are then conveyed to the transfer station 2. The transfer station 2 shown here also preferably comprises two largely identical automatic transfer units 6, 7 arranged one behind the other. The first conveyor belt 10 now transports the food portions 5 through the transfer station 2.

The optional second automatic transfer unit 7 is designed here in such a way that it can transfer 40 food portions 5 per minute to the further processing station 4 and arrange them there according to the specified format of the packaging trays. Accordingly, in this example, around 80 food portions 5 per minute are conveyed towards the first automatic transfer unit 6. Since this is largely identical to the second automatic transfer unit 7, it can also transfer around 40 food portions 5 per minute.

This leaves around 40 food portions 5 per minute, which are conveyed, in particular straight ahead, into the buffer station 3 onto the second conveyor belt 20 and stored there.

In this example, the further processing station 4 is designed to process around 80 food portions 5 per minute. The two automatic transfer units 6, 7 therefore ensure that the further processing station 4 can work without interruption, as it receives sufficient food portions 5 per minute. Thus, the processing station 1, the transfer station 2 and the further processing station 4 preferably work according to their predetermined capacity or working speed or working cycle.

FIG. 2b now shows a phase of the process in which the buffer station 3 is emptied. For the sake of simplicity, it is now assumed that the processing station 1 temporarily does not provide any new food portions 5. The skilled person understands that it is just as possible that the processing station 1 merely provides fewer food portions 5 (per minute) or, alternatively or additionally, that the buffer station 3 is completely or almost completely full and therefore needs to be emptied.

According to the embodiment shown here, the processing station 1 therefore provides 0 portions of food 5 per minute during this phase. The optional detection means 8 detects this and an optional, but preferred, control of the system controls the other components accordingly. The buffer station 3 is now emptied at a rate of around 80 food portions 5 per minute, as explained in more detail below. Irrespective of the specific conveying direction of the buffer station 3 and the transfer station 2, the stream of food portions now flows in the opposite direction to the first conveying direction 100. The first automatic transfer unit 6 can now continue to transfer some 40 food portions 5 per minute into the packaging troughs of the further processing station 4 and the remaining approximately 40 food portions 5 per minute are transferred by the second automatic transfer unit 7.

In this sense, the processing station 4 is preferably decoupled from the rest of the system and continues to work uninterruptedly with its own work cycle. In addition to simply storing the food portions 5, the buffer station 3 thus buffers the system to a certain extent and can advantageously compensate for fluctuations in the number of food portions 5 provided per minute caused by the processing station 1.

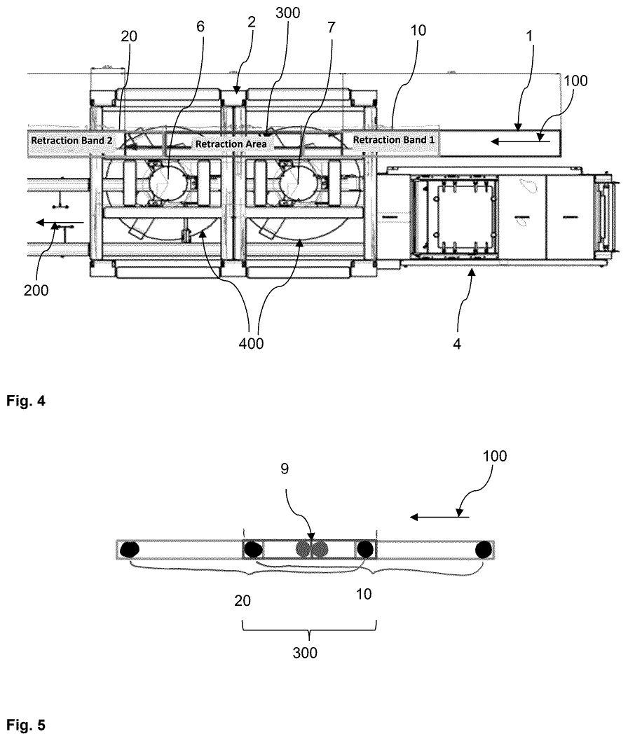

FIG. 3 shows a schematic top view of a system according to the invention according to an exemplary embodiment. The embodiment shown here essentially corresponds to the embodiments explained in connection with the other figures, so that the respective explanations also apply to this embodiment and vice versa.

As is indicated here, the first conveyor belt 10 and the processing station 1 are partially formed in one piece, i.e. there is no transfer edge between the processing station 1 and the first conveyor belt 10, at least in the example shown here and in the area shown here.

Alternatively, a conveyor belt area of the processing station 1 and the first conveyor belt 10 are formed in two parts. The second conveyor belt 20 according to the embodiment shown here is designed in two parts. There is a rear part 20′, which serves exclusively as a buffer belt, i.e. is not designed as a retraction belt, and a front part 20, which is designed as a retraction belt.

For example, the length of the rear part of the second conveyor belt 20′ is approximately 600 mm, while the front part of the second conveyor belt 20 has a length of approximately 1200 mm. The first conveyor belt 10 is about 800 mm long here. In the region of the transfer edge 9 between the first conveyor belt 10 and the second conveyor belt 20, a retraction region 300 is formed, here with a length of approximately 600 mm, for example, in which the transfer edge 9 and thus the first conveyor belt 10 and the second conveyor belt 20 can be moved.

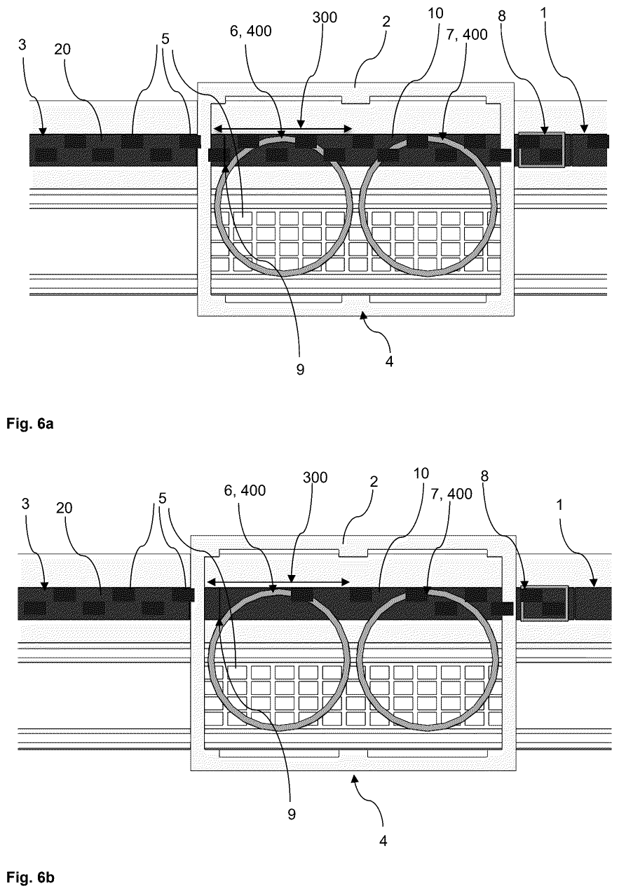

FIG. 4 shows a schematic top view of a system according to the invention in accordance with a further exemplary embodiment. The embodiment shown here essentially corresponds to the embodiments explained in connection with the other figures, so that the respective explanations also apply to this embodiment and vice versa. The embodiment shown in FIG. 4 now differs from the embodiment previously explained in connection with FIG. 3 in that the second conveyor belt 20 is designed in one piece and entirely as a retracting belt. In this case, the length of the second conveyor belt 20 in an initial position is approximately 1200 mm. In this example, the first conveyor belt 10 has the same length and the two retraction belts are designed in such a way that the retraction area 300, i.e. the area in which the transfer edge 9 can be moved, is also approximately 1200 mm.

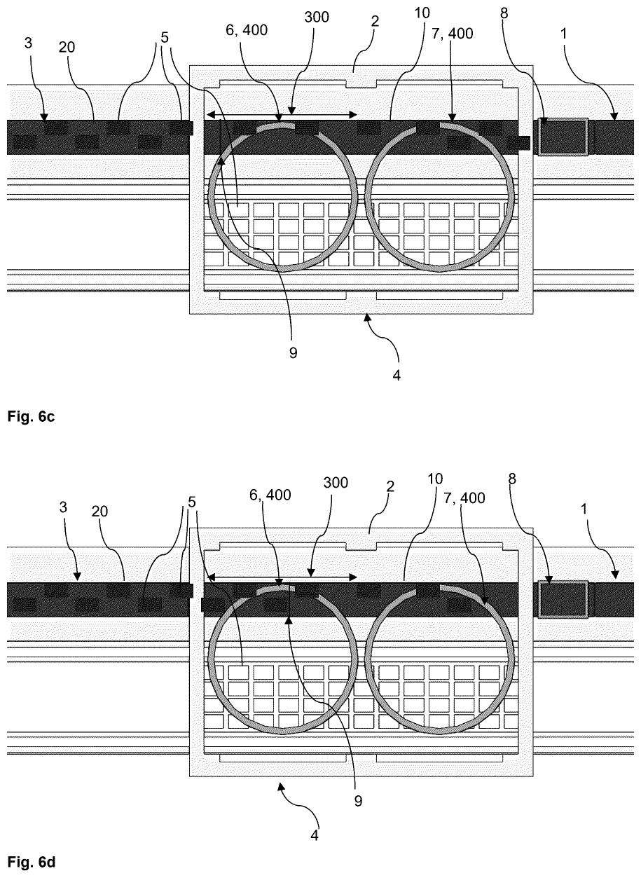

FIG. 5 shows a schematic representation of a first conveyor belt 10 and a second conveyor belt 20 according to an exemplary embodiment of the system according to the invention. The only simplified embodiment shown here can illustrate both the embodiment according to FIG. 3 and the embodiment according to FIG. 4. Also according to this embodiment, both the first conveyor belt 10 and the second conveyor belt 20 are each designed as a retracting belt. The movement of the respective edge 9 of the belt 10, 20 is effected by a roller, indicated here, around which the endless belt is guided and which can be moved parallel to the first conveying direction 100. The two conveyor belts 10, 20 are preferably moved synchronously at least occasionally in such a way that the distance between the two conveyor belts 10, 20 remains constant and thus food portions 5 can easily pass from the first conveyor belt 10 to the second conveyor belt 20 and vice versa. The length of the retraction area 300 is determined by the maximum possible change in length of the two conveyor belts 10, 20. Preferably, the distance between the conveyor belts 10, 20 can be varied so that, for example, a gap can be created between the conveyor belts 10, 20 through which food portions 5, for example faulty and/or incomplete food portions, can be discharged.

FIGS. 6a to 6f show a schematic representation of a method according to the invention according to an exemplary embodiment at different points in time. The embodiment shown here essentially corresponds to the embodiments explained in connection with the other figures, so that the respective explanations also apply to this embodiment and vice versa. This applies in particular to the embodiment shown in FIG. 1, which essentially corresponds to the embodiment shown here. According to the embodiment shown in FIGS. 6a to 6f, the food portions 5 are conveyed from the processing station 1 to the first conveyor belt 10 by means of a conveyor belt. However, this is exemplary. It is also conceivable that the processing station 1 transports the food portions 5 directly or indirectly onto the first conveyor belt 10. According to this exemplary embodiment, the first conveying direction 100 runs from right to left. The second direction 200 of the further processing station 4 here runs parallel to the first conveying direction 100, but is otherwise independent of the first conveying direction 100 in its direction, i.e. the second direction 200, in which the further processing station 4 operates, can (in the section shown here) run both from right to left and vice versa, without this affecting the method explained here.

FIG. 6a shows a hypothetical point in time in the process, in which food portions 5 are provided by the processing station 1 in a more or less continuous sequence and are conveyed through the transfer station 2 and into the buffer station 3. Both the first conveyor belt 10 and the second conveyor belt 20 are designed as retracting belts. The transfer edge 9 between the two belts 10, 20 is indicated here. In this state, the transfer edge 9 is positioned at the exit of the transfer station 2. This transfer edge 9 and thus the transition between the first conveyor belt and the second conveyor belt 20 can be moved here in the opposite direction to the first conveying direction 100, i.e. to the right in the illustration (and back).

In FIG. 6b, the automatic transfer units 6 and 7 are now working, as symbolized by the density of food portions 5. From the right, all the food portions 5 are transferred to the first conveyor belt 10 and into the transfer station 2, where the second automatic transfer unit 7 removes a first portion of the food portions 5 in its working area 400 and transfers them to the further processing station 4, for example into the packaging trays produced there and/or the packaging parts provided there. A second portion of the food portions 5 is transferred downstream by the first automatic transfer unit 6 within its working area 400 to the further processing station 4. A third portion of the food portions 5 is conveyed further downstream to the second conveyor belt 20 of the buffer station 3 and temporarily stored there.

FIG. 6c shows a point in time at which, for example, the processing station 1 must be reloaded or the flow of food portions 5 is reduced or stops for other reasons. The detection means 8, which in this example is arranged at the entrance of the transfer station 2, recognizes this, for example by detecting that the occupancy of the first conveyor belt 10 with food portions 5 falls below a predetermined value. This is preferably reported to the control system of the system, which in turn particularly preferably causes the first conveyor belt 10 to continue running with a lower probability, so that the first automatic transfer unit and the second automatic transfer unit can capture and transfer as many of the remaining food portions 5 as possible. The first conveyor belt 10 empties. The buffer station 3 is now only filled slowly or not at all.

As soon as no more food portions 5 arrive at the exit of the transfer station 2, which is detected, for example, by a further detection means not shown here, the retraction belts are activated, as shown in FIG. 6d, and the transfer edge 9 is moved to the right into the area of the transfer station 2. As a result, the food portions 5 stored on the second conveyor belt 20 now first enter the working area 400 of the first automatic transfer unit 6 and are partially transferred by this to/into the further processing station 4. There is thus preferably a seamless transition from the gripping of food portions 5 on the first conveyor belt 10 to the gripping of food portions 5 on the second conveyor belt 20 by the first automatic transfer unit 6. Since the second automatic transfer unit is arranged upstream, it still has sufficient food portions available on the first conveyor belt 10.

At the point in time shown in FIG. 6e, the second transfer unit 7 has transferred the remaining food portions 5 from the first conveyor belt 10. The transfer edge 9 is now located, for example, approximately in the middle of the transfer station 2. Preferably, the conveying direction of the first conveyor belt 10 and/or the second conveyor belt 20 is now reversed, so that the food portions 5 are now moved from left to right and thus in the opposite direction to the first conveying direction 100.

In this way, the food portions from the buffer station 3 also reach the working area 400 of the second automatic transfer unit 7 and can be transferred from this to the further processing station. This is shown in FIG. 6f. The buffer station 3 is thus emptied. The system is preferably controlled in such a way that the further processing station 4 is not interrupted and the buffer station 3 does not overflow. The skilled person understands that this can be achieved both by multi-track conveyor belts and by selecting the operating speed of the individual components of the system and coordinating them with each other.

### LIST OF REFERENCE SYMBOLS

1 Processing station
2 Transfer station
3 Buffer station
4 Further processing station
5 Food portions
6 First automatic transfer unit
7 Second automatic transfer unit
8 Detection means
9 Transfer edge
10 First conveyor belt
20, 20′ second conveyor belt
100 First conveying direction
200 second direction
300 Retreat area
400 Working area

1. System for processing food portions, the system comprising:
at least one processing station arranged upstream for producing and/or processing the food portions,
at least one further processing station arranged downstream for further processing the food portions,
at least one transfer station arranged downstream of the processing station and upstream of the further processing station, the at least one transfer station having at least one first automatic transfer unit for transferring the food portions from the processing station to the further processing station and having a first conveyor belt for conveying the food portions along a first conveying direction, and at least one buffer station arranged downstream of the transfer station for intermediate storage of the food portions with a second conveyor belt for conveying and intermediate storage of food portions,
wherein the first conveyor belt and the second conveyor belt are designed as retracting belts.

2.-19. (canceled)

20. System according to claim 1, wherein a distance between transfer edges of the first conveyor belt and the second conveyor belt is essentially constant.

21. System according to claim 20, wherein a distance between the first conveyor belt and the second conveyor belt in a region of the transfer edges can be varied at least in two stages to create a gap at least temporarily between the first conveyor belt and the second conveyor belt.

22. System according to claim 1, wherein the second conveyor belt is arranged at least temporarily on a different plane than the first conveyor belt.

23. System according to claim 1, wherein a conveying direction of the first conveyor belt and/or of the second conveyor belt is temporarily reversible.

24. System according to claim 1, wherein the further processing station is aligned along a second direction, the first conveying direction and the second direction being provided parallel to one another at least in sections, the first conveying direction being unequal to the second direction, the first conveying direction and/or the second direction being provided in a straight line at least in sections.

25. System according to claim 24, wherein the first conveyor belt and the second conveyor belt are arranged along the first conveying direction in a rectilinear extension of the processing station and/or directly adjacent thereto.

26. System according to claim 1, wherein the transfer station comprises a second automatic transfer unit for transferring the food portions from the processing station to the further processing station, wherein the second automatic transfer unit is arranged along the first conveying direction between the first automatic transfer unit and the buffer station or between the processing station and the first automatic transfer unit.

27. System according to claim 1, wherein the first automatic transfer unit and/or the second automatic transfer unit is provided movable in three dimensions and/or rotatable about at least one axis, or in two or three axes aligned perpendicular to one another, the first automatic transfer unit and/or the second automatic transfer unit comprising at least one robot for picking up and transferring the food portions.

28. System according to claim 1, wherein the first conveyor belt and/or the second conveyor belt comprises an endless belt.

29. System according to claim 1, wherein the system further comprises at least one detection means or an optical detection means, for detecting the food portions, wherein the detection means or the optical detection means is arranged in a region of the processing station, the first conveyor belt, and/or the second conveyor belt.

30. System according to claim 1, wherein the processing station, the first conveyor belt, the second conveyor belt, and/or the further processing station is provided with multiple tracks.

31. System according to claim 30, wherein the first conveyor belt and the second conveyor belt have a same number of tracks, the first conveyor belt and the second conveyor belt having a number of tracks which is unequal to a number of tracks of the further processing station.

32. System according to claim 1, wherein the first conveyor belt and the second conveyor belt are arranged at least temporarily in one plane, so that the food portions are arranged on a horizontal conveying plane

33. Method for operating the system according to claim 1, wherein the food portions are produced by the processing station and conveyed along the first conveying direction by the first conveyor belt in the direction of the second conveyor belt, wherein the transfer station transfers the food portions from the first conveyor belt to the further processing station, wherein non-converted food portions are conveyed to the second conveyor belt of the buffer station for intermediate storage, wherein the first conveyor belt and the second conveyor belt are moved in an opposite direction to the first conveying direction when a predetermined first condition is fulfilled.

34. Method according to claim 33, wherein the system comprises at least one detection means or an optical detection means, for detecting the food portions, wherein the detection means or the optical detection means is arranged in a region of the processing station, the first conveyor belt and/or the second conveyor belt and detects occupancy, wherein a predetermined first condition is fulfilled when the occupancy falls below a predetermined first value.

35. Method according to claim 34, wherein a conveying direction of the first conveyor belt and/or the second conveyor belt is temporarily reversed when a predetermined second condition is fulfilled, wherein the predetermined second condition is fulfilled when the occupancy falls below a predetermined second value, wherein the second value is less than the first value.

36. The method according to claim 33, wherein a speed of the first conveyor belt and/or the second conveyor belt is controlled as a function of the detected occupancy.

37. Method according to claim 33, wherein a gap between the first conveyor belt and the second conveyor belt is generated at least temporarily in a targeted manner.
